(19) United States
(12) Patent Application Publication
(10) Pub. No.: US 2017/0139579 A1
(43) Pub. Date: May 18, 2017

(54) Method and Device for Displaying User-Defined Control based on Android Platform

(71) Applicants: Le Holdings (Beijing) Co., Ltd., Beijing (CN); Le Shi Internet Information Technology Corp. Beijing, Beijing (CN)

(72) Inventor: Wei Jiang, Beijing (CN)

(21) Appl. No.: 15/247,313

(22) Filed: Aug. 25, 2016

Related U.S. Application Data
(63) Continuation of application No. PCT/CN2016/082800, filed on May 20, 2016.

(30) Foreign Application Priority Data
Nov. 16, 2015 (CN) 201510784838.9
May 20, 2016 (CN) PCT/CN2016/082800

(51) Int. Cl. G06F 3/0484; G06F 9/54; G06F 3/0482

(52) U.S. Cl. CPC G06F 3/04847; G06F 3/0482; G06F 9/543

(57) ABSTRACT

The present application discloses a method and a device for displaying user-defined control based on Android platform. The method includes: detecting an instruction of opening a user-defined control in an application interface; invoking a user-defined control interface of the application, and reading a user-defined control packed in an Android system and corresponding to the application, wherein the user-defined control interface defines select controls corresponding to the style of the application interface included in the user-defined control, a logical relation between the select controls, and a display category of the user-defined control; and displaying the select control according to the display category and the logical relation when the user-defined control is displayed in the application interface.

### CROSS-REFERENCE TO RELATED APPLICATIONS

This application is a continuation of PCT international application No. PCT/CN2016/082800, filed May 20, 2016, which claims priority to Chinese Patent Application No. 201510784838.9, filed on Nov. 16, 2015, the entire contents of which are incorporated herein by reference.

### TECHNICAL FIELD

The present disclosure belongs to the field of internet technologies, and more particularly, relates to a method and a device for displaying user-defined control based on Android platform.

### BACKGROUND

With the increasing user demands, there are more and more applications (app) designed for a mobile terminal, while these applications need to depend on an operating system of the mobile terminal during development, such as Android, ios, mac, or the like.

Presently, the Android platform has a severe fragmentation problem. Various devices, numerous brands, different versions, and non-uniform resolutions or the like, have gradually become obstacles for the development of an Android system. Severe fragmentation not only causes disorders of the Android system, but also increases the hidden development cost of Android applications.

Taking such a more common control like a date select box for example, an Android system version has numerous date boxes with various use manners, while most date boxes are tedious and bring poorer experience to users. A universal solution at present is to select a low version software development kit (SDK) of the Android system, and use an original date select box provided by the low version SDK. Because the Android system belongs to downward compatibility, the uniform use of the date select box can be satisfied. However, because each application has a style thereof, while the original control of the Android system is not allowed to be self-modified by a developer, using the original control of the Android system will be dramatically different from the entire style of an application interface in most times regarding the aspects of color and patterns.

### SUMMARY

In light of this, the embodiments of the present disclosure provide a method and a device for displaying user-defined control based on Android platform, for solving the technical problem in the prior art that the original control of the Android system used is dramatically different with the entire style of the interface of the application thereof.

In order to solve the foregoing technical problem, the present disclosure discloses a method for displaying user-defined control based on Android platform, including: detecting an instruction of opening a user-defined control in an application interface; invoking a user-defined control interface of the application, and reading a user-defined control packed in an Android system and corresponding to the application, wherein the user-defined control interface defines select controls corresponding to the style of the application interface included in the user-defined control, a logical relation between the select controls, and a display category of the user-defined control; and displaying the select control according to the display category and the logical relation, when the user-defined control is displayed in the application interface.

In order to solve the foregoing technical problem, the present disclosure also discloses a device for displaying user-defined control based on Android platform, including: an instruction detecting module configured to detect an instruction of opening a user-defined control in an application interface; a control reading module configured to invoke a user-defined control interface of the application, and read the user-defined control packed in an Android system and corresponding to the application, wherein the user-defined control interface defines select controls corresponding to the style of the application interface included in the user-defined control, a logical relation between the select controls, and a display category of the user-defined control; and a control displaying module configured to display the select control according to the display category and the logical relation when the user-defined control is displayed in the application interface.

In order to solve the foregoing technical problem, the present disclosure also discloses a device for displaying user-defined control based on Android platform, including: a processor; and a memory for storing instructions executable by the processor; wherein the processor is configured to: detect an instruction of opening a user-defined control in an application interface; invoke a user-defined control interface of the application, and read the user-defined control packed in an Android system and corresponding to the application, wherein the user-defined control interface defines select controls corresponding to the style of the application interface included in the user-defined control, a logical relation between the select controls, and the display category of the user-defined control; and display the select control according to the display category and the logical relation when the user-defined control is displayed in the application interface.

Compared with the prior art, the method and the device for displaying user-defined control based on Android platform according to some embodiments of the present disclosure, after receiving the instruction of opening the user-defined control in the application interface, invoke the user-defined control interface of the application to read the user-defined control packed in the Android system and corresponding to the application, so that the user-defined control is closer to the style of the application interface, and the style of the interface is more uniform and beautiful when the user-defined control is displayed in the application. Because the user-defined controls read by the application are uniformly packed in the Android operating system, the user-defined controls can be invoked by different applications, which satisfies the display demands of different applications on the user-defined control while assuring the uniform pattern of the user-defined control.

It is to be understood that both the foregoing general description and the following detailed description are exemplary and explanatory only and are not restrictive of the present disclosure.

### BRIEF DESCRIPTION OF THE DRAWINGS

In order to explain the technical solutions in the embodiments of the disclosure or in the prior art more clearly, the drawings used in the descriptions of the embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of a method for displaying user-defined control based on Android platform according to some embodiments of the present disclosure;

FIG. 2 is a flow chart of a method for displaying user-defined control based on Android platform according to some embodiments of the present disclosure;

FIG. 3 is a flow chart of a method for displaying user-defined control based on Android platform according to some embodiments of the present disclosure;

FIG. 4 is a flow chart of a method for displaying user-defined control based on Android platform according to some embodiments of the present disclosure; and

FIG. 5 is a flow chart of a method for displaying user-defined control based on Android platform according to some embodiments of the present disclosure;

FIG. 6 is a block diagram of a device for displaying user-defined control based on Android platform according to some embodiments of the present disclosure.

Particular embodiments of the present disclosure have been shown through the accompanying drawings above, and will be described in detail hereinafter. The accompanying drawings and text descriptions are not intended to limit the scope of the conception of the present disclosure through any manner, but to explain the concept of the present disclosure for those skilled in the art with reference to specific embodiments.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without going through creative efforts shall all fall within the protection scope of the present disclosure.

According to some embodiments of the present disclosure, when the application is installed in the mobile terminal used by the user, the mobile terminal displays the application interface; after the instruction of opening the user-defined control in the application interface, the user-defined control interface of the application is invoked to read the user-defined control packed in the Android system and corresponding to the application, and the user-defined control is displayed according to the select controls which is defined by the user-defined control interface and is corresponding to the style of the application interface, the logical relation between the select controls, and the display category of the user-defined control. So that the user-defined control is closer to the style of the application interface, and the style of the interface is more uniform and beautiful when the user-defined control is displayed in the application. Because the user-defined controls read by the application are uniformly packed in the Android operating system, the user-defined controls can be invoked by different applications, which satisfies the display demands of different applications on the user-defined control while assuring the uniform pattern of the user-defined control.

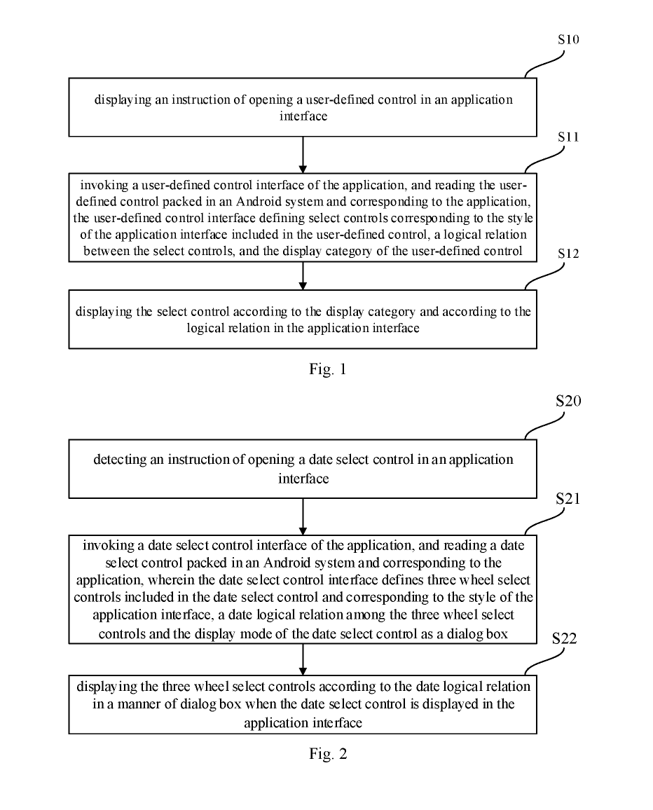

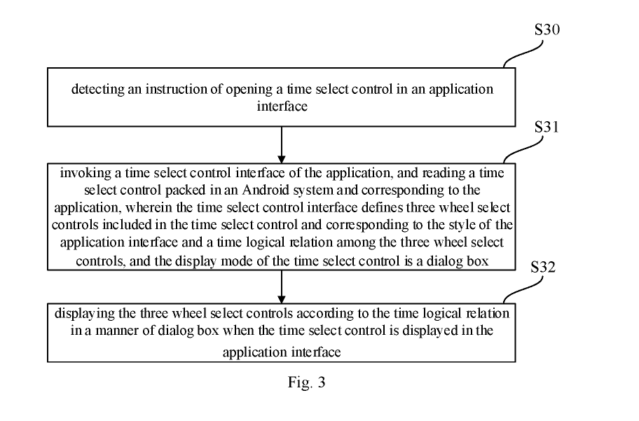

FIG. 1 is a method for displaying user-defined control based on Android platform according to some embodiments of the present disclosure, which is applied to a terminal device, wherein the terminal device can be a mobile phone, a computer, a digital broadcast terminal, a messaging device, a gaming console, an on-vehicle console, a tablet device, a medical device, an exercise equipment, a personal digital assistant, or the like. As shown in FIG. 1, the method includes the following steps S10-S12.

In step S10, an instruction of opening a user-defined control in an application interface is detected.

The terminal equipment, after running the application, displays the application interface. The interface includes an entrance of opening the user-defined control. When a user performs a select or click operation with respect to the entrance, the instruction of opening the user-defined control is triggered, and the instruction of opening the user-defined control is detected by the terminal equipment.

The user-defined control is a control which is developed by a developer and is different from the original control of the Android system, so that the style of the application interface is more uniform, bringing preferable user interaction effects.

In step S11, a user-defined control interface of the application is invoked, and the user-defined control packed in the Android system and corresponding to the application is read, wherein the user-defined control interface defines select controls corresponding to the style of the application interface included in the user-defined control, a logical relation between the select controls, and the display category of the user-defined control.

During the development process, in order to assure that the application can directly use the user-defined control packed in the Android operating system, the user-defined control in the application interface needs to be defined through the user-defined control interface, wherein the user-defined control includes but is not limited to the select control, the logical relation and the display category.

The select control is configured to interact with the user to finish selecting the displayed contents; for example, a spinner select control (Spinner), a wheel select control (WheelView), a scroll select control (ScrollView), and a list select control (ListView) are common select controls. A certain number of select controls are set according to the contents that need to be displayed by the user-defined control, and resource pictures corresponding to the contents displayed by each select control are designated.

The logical relation is a logical relation between the display contents of the select controls, for example, a date logical relation, a time logical relation, or the like.

The display category is a form of the user-defined control displayed in the application interface, for example, a dialog box (PopupWindow or AlertDialog), an input box (EditText), or the like.

The foregoing contents of the user-defined control are packed in the SDK of the Android operating system; after the instruction of opening the user-defined control is received, the foregoing contents are read through the user-defined control interface.

In step S12, the select control is displayed according to the display category and according to the logical relation in the application interface.

In some embodiments, after receiving the instruction of opening the user-defined control in the application interface, the user-defined control interface of the application is invoked to read the user-defined control packed in the Android system and corresponding to the application, so that the user-defined control is closer to the style of the application interface, and the style of the interface is more uniform and beautiful when the user-defined control is displayed in the application. Because the user-defined controls read by the application are uniformly packed in the Android operating system, the user-defined controls can be invoked by different applications, which satisfies the display demands of different applications on the user-defined control while assuring the uniform pattern of the user-defined control.

In some embodiments, the user-defined control is a date select control. As shown in FIG. 2, the foregoing method for displaying user-defined control based on Android platform may be further implemented as the following steps S20-S22.

In step S20, an instruction of opening a date select control in an application interface is detected.

In step S21, a date select control interface of the application is invoked, and a date select control packed in an Android system and corresponding to the application is read, wherein the date select control interface defines three wheel select controls corresponding to the style of the application interface included in the date select control, a date logical relation among the three wheel select controls and the display mode of the date select control as a dialog box.

The date select control includes three wheel select controls (WheelView), Representing “year”, “month” and “day” respectively. The current “year”, “month” and “day” may be acquired through acquiring a calendar subcategory in the system, thus forming the date logical relation among the three wheel select controls. For example:
calendar=Calendar.getInstance( );
int year=calendar.get(Calendar.YEAR);
intmonthOfYear=calendar.get(Calendar.MONTH);
intdayOfMonth=calendar.get(Calendar.DAY_OF_MONTH).

Meanwhile, views corresponding to the “year”, “month” and “day” respectively are configured for the three wheel select controls, for displaying corresponding date numbers. For example, a view from number 1900 to 2199 is configured for the first wheel select controls representing “year”, a view from number 01 to 12 is configured for the second wheel select controls representing “month”, and a view from number 01 to 31 is configured for the third wheel select controls representing “day”. Associated changes of the date logical relation among the three wheel select controls is implemented through a listener, for example, OnWheelChangedListener.

Then, the display position of a dialog box for displaying the date select control is defined, for example, the display position of the date select control in a screen and the display positions of the three wheel select controls are defined through PopupWindow or AlertDialog.

In step S22, the three wheel select controls are displayed according to the date logical relation in a manner of dialog box when the date select control is displayed in the application interface.

When the dialog box is implemented using PopupWindow, after the dialog box of the date select control is popped up, the user may still interact with other contents in the application interface, so that the interactive design of the application has better expansibility.

The date select control may be displayed in the application interface for the user to view the current date; if it is desirable to allow the user to modify the date displayed by the date select control, then the date select control needs to be further added with a listener to capture an event of modified date, for example, OnDateChangedListener, and the corresponding implementation codes are as follows:

datePicker.init(year, monthOfYear, dayOfMonth, newOnDateChangedListener( ){

public void onDateChanged(DatePicker view, int year,

intmonthOfYear, intdayOfMonth)

{dateEt.setText(“the date you selected is:” +year+“year”+(monthOfYear+1)+“month”+dayOfMonth+“day.”);

}.

In some embodiments, after receiving the instruction of opening the date select control in the application interface, the date select control interface of the application is invoked to read the date select control packed in the Android system and corresponding to the application, which implements the uniform pattern of the user-defined control while displaying the date select control in the application interface. Because the date select control read by the application is uniformly packed in the Android operating system, the date select control can be invoked by different applications, which satisfies the display demands of different applications on the date select control while assuring the uniform pattern of the date select control.

In some embodiments, the user-defined control is a time select control. As shown in FIG. 2, the foregoing method for displaying user-defined control based on Android platform may be further implemented as the following steps S30-S32.

In step S30, an instruction of opening a time select control in an application interface is detected.

In step S31, a time select control interface of the application is invoked, and a time select control packed in the Android system and corresponding to the application is read, wherein the time select control interface defines three wheel select controls corresponding to the style of the application interface included in the time select control, a time logical relation among the three wheel select controls and the display mode of the time select control as a dialog box.

The time select control includes three wheel select controls (WheelView), representing “hour”, “minute” and “second” respectively. The current “hour”, “minute” and “second” may be acquired through acquiring a current time subcategory in the system, thus forming the time logical relation among the three wheel select controls. For example:
Int hour=time.getCurrentHour(Time.HOUR);
intminute=time.getCurrentMinute(Time.MINUTE);
intsecond=time.getCurrentSecond(Time.SECOND).

Meanwhile, views corresponding to the “hour”, “minute” and “second” respectively are configured for the three wheel select controls, for displaying corresponding time numbers. For example, a view from number 0 to 24 or 0 to 12 is configured for the first wheel select controls representing “hour”, a view from number 00 to 59 is configured for the second wheel select controls representing “minute”, and a view from number 00 to 59 is configured for the third wheel select controls representing “second”. Associated changes of the time logical relation among the wheel select controls is implemented through a listener, for example, OnWheelChangedListener.

Then, the display position of a dialog box for displaying the time select control is defined, for example, the display position of the time select control in a screen and the display positions of the three wheel select controls are defined through PopupWindow or AlertDialog.

In step S32, the three wheel select controls are displayed according to the time logical relation in a manner of dialog box when the time select control is displayed in the application interface.

Similarly, when the dialog box is implemented using PopupWindow, after the dialog box of the time select component is popped up, the user may still interact with other contents in the application interface, so that the interactive design of the application has better expansibility.

The time select control may be displayed in the application interface for the user to view the current time; if it is desirable to allow the user to modify the date displayed by the time select control, then the time select control needs to be further added with a listener to capture an event of modified time, for example, OnTimeChangedListener, and the corresponding implementation codes are as follows:

setOnTimeChangedListener(new OnTimeChangedListener( ){public void onTimeChanged(TimePicker view, inthourOfDay, int minute){

timeEt.setText(“the time you selected is:”+hourOfDay+“hour”+minute+“minute.”);

}.

In some embodiments, after receiving the instruction of opening the time select control in the application interface, the time select control interface of the application is invoked to read the time select control packed in the Android system and corresponding to the application, which implements the uniform pattern of the user-defined control while displaying the time select control in the application interface. Because the time select control read by the application is uniformly packed in the Android operating system, the time select control can be invoked by different applications, which satisfies the display demands of different applications on the time select control while assuring the uniform pattern of the time select control.

The date select control and the time select control mentioned above include three wheel select controls respectively. In some embodiments, it does not need to display all the “year”, “month” and “day” in the date and the “hour”, “minute” and “second” in the time according to the actual requirements of the application interface sometimes. For example, it needs to only display the “month” and “day” in the date and needs to only display the “hour” and “minute” in the time sometimes, then the attributes of the wheel select controls representing the “month” and “day” or the wheel select controls representing the “hour” and “minute” need to be set as “visible”, and the attributes of the wheel select controls representing the “year” or “second” need to be set as “gone”. At this moment, the settings for the date select control are as follows:

Year view.setVisibility(View.GONE);

monthOfYearview.setVisibility(View.VISIBLE);

dayofMonth.set Visibility(View.VISIBLE);

the settings for the time select control are as follows:

Hourview.setVisibility(View.VISIBLE);

Minuteview.setVisibility(View.VISIBLE);

Secondview.setVisibility(View.GONE).

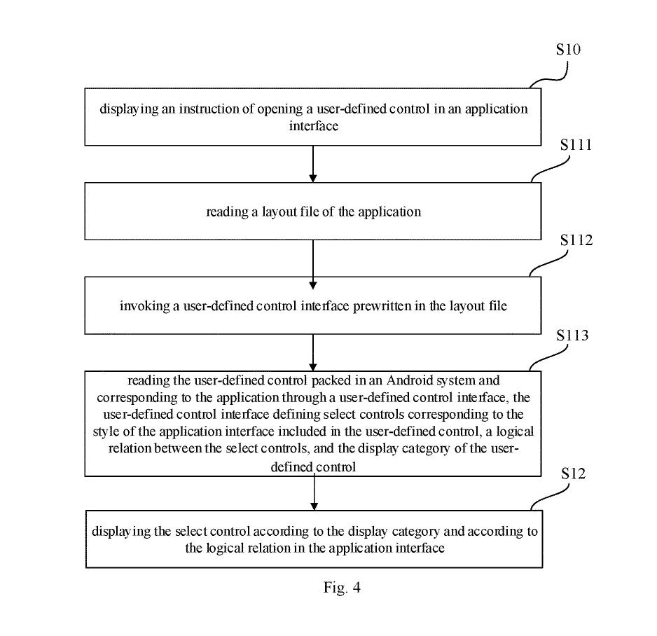

In some embodiments, the user-defined control is defined in a layout file of the application. At this moment, step S11 as shown in FIG. 4 may be further implemented as the following steps S111-S113.

In step S111, the layout file of the application is read.

The layout file is packed in an installation package of the application, and is released to the operating system of the terminal equipment when the application is installed in the terminal equipment.

In step S112, a user-defined control interface prewritten in the layout file is invoked.

In step S113, the user-defined control packed in the Android system and corresponding to the application is read through a user-defined control interface, the user-defined control interface defining select controls corresponding to the style of the application interface included in the user-defined control, a logical relation between the select controls, and the display category of the user-defined control.

The layout file may be configured to describe the display patterns of each view, for example, a layout file in an XML format may be used to describe the view defined in the Android system. During the actual development process, in order to define the user-defined control in the layout file, the user-defined control interface may be invoked in the layout file, so as to define the user-defined control. In a probable implementation manner, taking a time select control interface for example, codes for the time select control interface to define the time select control are as follows:
<TimePickerandroid:id=“@+id/timePicker”
android:lay out_width=“wrap_content”
android:lay out_height=“wrap_content”
android:lay out_gravity=“center_horizontal”/>;

wherein, android:layout_width=“wrap_content”, android:layout_height=“wrap_content” and android:lay out_gravity=“center_horizontal” are used to define the height, width and central point of the time selection control, fill up the entire window, and are centered.

When the user-defined control is defined in the layout file, not only the display mode of each element in the user-defined control can be defined, but also the length and width of the user-defined control and the color and typeface displayed by each element can be defined.

It should be noted that during the development process, a developer has already invoked the user-defined control interface in the layout file of the application, and defines the display pattern of the user-defined control; after the application is published, the display pattern of the user-defined control is already determined as well. At this moment, the layout file may be packed in the installation package of the application, and the installation package is published.

After the terminal equipment acquires the installation package, the application may be installed, and the layout file of the application may be released in an operating system installed in the terminal equipment when installing the application. When the application is being used, because the application needs to display the user-defined control, the layout file of the application may be read while reading the application, and the user-defined control interface prewritten in the layout file may be invoked in the layout file, and the user-defined control packed in the operating system may be read, i.e., a preset number of select controls included in the user-defined control and corresponding to the style of the application interface, a logical relation among the select controls, and the contents of the display category of the user-defined control are acquired.

The user of the application cannot change the display pattern of the user-defined control of the application, while the user-defined control that will be displayed in the application may be re-defined in the layout file of the application only when the developer of the application is developing or upgrading the application.

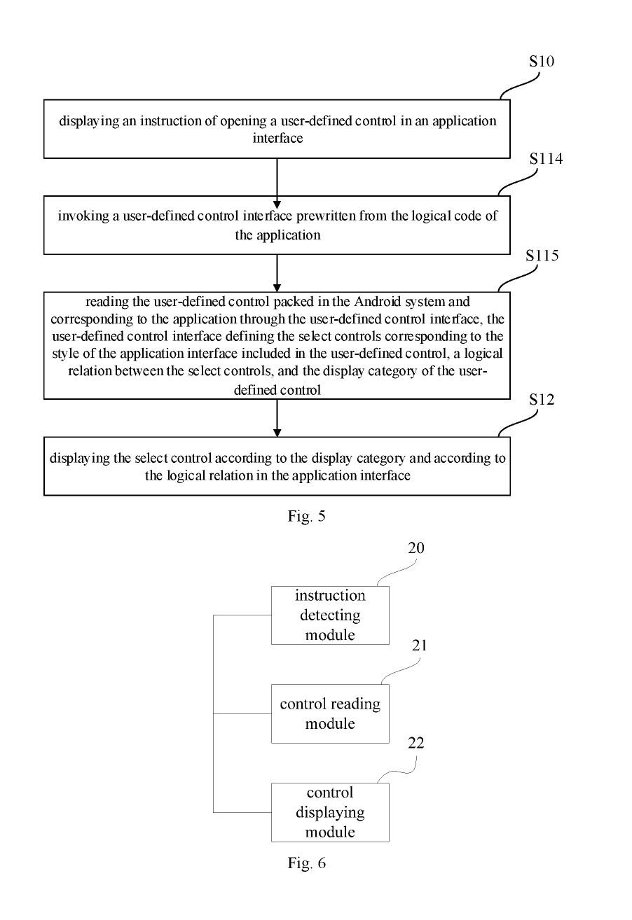

In some embodiments, the user-defined control is defined in a logical code of the application. At this moment, step S11 as shown in FIG. 5 may be further implemented as the following steps S114-S115.

In step S114, the user-defined control interface prewritten is invoked from the logical code of the application.

In step S115, the user-defined control packed in the Android system and corresponding to the application is read through the user-defined control interface, wherein the user-defined control interface defines the select controls corresponding to the style of the application interface included in the user-defined control, the logical relation between the select controls, and the display category of the user-defined control.

During the development process of the application, the developer may directly embed a defining code segment in the logical code of the application, i.e., the defining code segment may invoke the user-defined control interface so as to define the display pattern of the user-defined control. In a probable implementation manner, taking a time select control for example, the codes are specifically defined as follows:

TimePicker.showHourPicker(true);

TimePicker.showMinutePicker(true);

TimePicker.showSecondPicker(true);

wherein, the display modes of the three wheel select controls representing the “hour”, “minute” and “second” are all defined as display through invoking the three functions above.

Some embodiments of devices of the present disclosure are described hereinafter, which may be used for performing the foregoing method according to the embodiments of the present disclosure.

FIG. 6 is a device for displaying user-defined control based on Android platform according to some embodiments of the present disclosure, which is located at a terminal equipment side, wherein the device includes: an instruction detecting module 20, a control reading module 21 and a control displaying module 22.

The instruction detecting module 20 is electrically connected to the control reading module 21, and is configured to detect an instruction of opening a user-defined control in an application interface.

The control reading module 21 is electrically connected to the control displaying module 22, and is configured to invoke a user-defined control interface of the application, and read the user-defined control packed in an Android system and corresponding to the application, the user-defined control interface defining select controls corresponding to the style of the application interface included in the user-defined control, a logical relation between the select controls, and the display category of the user-defined control.

The control displaying module 22 is configured to display the select control according to the display category and according to the logical relation when the user-defined control is displayed in the application interface.

In some embodiments, the user-defined control is a date select control, the date select control includes three wheel select controls, a date logical relation is formed among the three wheel select controls, and the display category is a dialog box; and the control displaying module 22 further includes:

a first displaying submodule configured to display the three wheel select controls according to the date logical relation in a manner of dialog box when the date select control is displayed in the application interface.

In some embodiments, the user-defined control is a time select control, the time select control includes three wheel select controls, a time logical relation is formed among the three wheel select controls, and the display category is a dialog box; and the control displaying module 22 further includes:

a second displaying submodule configured to display the three wheel select controls according to the time logical relation in a manner of dialog box when the time select control is displayed in the application interface.

In some embodiments, the control reading module 21 further includes: a layout file reading submodule and a first invoking submodule.

The layout file reading submodule is electrically connected to the first invoking submodule, and is configured to read a layout file of the application; and

the first invoking submodule is configured to invoke the user-defined control interface prewritten in the layout file;

or, the control reading module 21 further includes:

a second invoking submodule configured to invoke the user-defined control interface prewritten from the logical code of the application.

Furthermore, each functional module above in the embodiments of the present disclosure can be implemented through a hardware processor.

The embodiments of the present disclosure provide a device for displaying user-defined control based on Android platform, including: a processor; and a memory for storing instructions executable by the processor; wherein the processor is configured to:

detect an instruction of opening a user-defined control in an application interface; invoke a user-defined control interface of the application, and read the user-defined control packed in an Android system and corresponding to the application, wherein the user-defined control interface defines select controls corresponding to the style of the application interface included in the user-defined control, a logical relation between the select controls, and the display category of the user-defined control; and display the select control according to the display category and according to the logical relation when the user-defined control is displayed in the application interface.

In some embodiments, the user-defined control is a date select control, the date select control includes three wheel select controls, a date logical relation is formed among the three wheel select controls, and the display category is a dialog box; and

the displaying the select control according to the display category and according to the logical relation when the user-defined control is displayed in the application interface includes:

displaying the three wheel select controls according to the date logical relation in a manner of dialog box when the date select control is displayed in the application interface.

In some embodiments, the user-defined control is a time select control, the time select control includes three wheel select controls, a date logical relation is formed among the three wheel select controls, and the display category is a dialog box; and

the displaying the select control according to the display category and according to the logical relation when the user-defined control is displayed in the application interface includes:

displaying the three wheel select controls according to the time logical relation in a manner of dialog box when the time select control is displayed in the application interface.

In some embodiments, the attributes of at least two of the wheel select controls are preset as display in the foregoing date display controls or time display controls.

In some embodiments, the invoking the user-defined control interface of the application includes:

reading a layout file of the application;

invoking the user-defined control interface prewritten in the layout file;

or,

invoking the user-defined control interface prewritten from the logical code of the application.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Furthermore, the method according to the present disclosure may also be implemented as a computer program executed by a CPU, wherein the computer program may be stored in a computer readable storage medium. When the computer program is executed the CPU, the functions defined above in the method of the present disclosure can be executed.

Further, the above method steps and system units may be implemented using a controller and the computer-readable storage medium used for storing a computer program that may cause the controller to implement the functions of the above steps or units.

Further, it should be understood that the described computer-readable storage medium (e.g., memory) may be a volatile memory or a non-volatile memory, or may include both the volatile memory and the non-volatile memory. As a non-limiting example, the non-volatile memory may include a read-only memory (ROM), a programmable ROM (PROM), an electrically programmable ROM (EPROM), an electrically erasable programmable ROM (EEPROM), or a flash memory. The volatile memory may include a random-access memory (RAM), and the RAM may be used as an external cache memory. As a non-limiting example, the RAM may be obtained in various forms such as a synchronous RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct RambusRAM (DRRAM). It is intended that the disclosed storage device includes, but is not limited to, these and other suitable types of memory.

Those skilled in the art will also understand that the disclosed various exemplary logic blocks, modules, circuits and algorithm steps herein may be implemented in electronic hardware, computer software or a combination thereof. In order to clearly illustrate the interchangeability between the hardware and the software, the interchangeability has been generally described via the functions of the various exemplary components, blocks, modules, circuits and algorithm steps. Whether the functions are implemented in hardware or software depends on the specific application and the design limitation imposed on the entire system. Those skilled in the art may use a variety of ways to implement the described functionalities for each specific application. However, such implementation decision should not be interpreted as departing from the scope of the present disclosure.

The various exemplary logic blocks, modules, and circuits described herein may be implemented or executed by using the following components designed to execute the disclosed functions: a general-purpose processor, a digital signal processor (DSP), an application specific integrated circuit (ASIC), a field programmable gate array (FPGA) or other programmable logic device, a discrete gate or a transistor logic, discrete hardware components, or any combination of these components. The general-purpose processor may be a microprocessor or, alternatively, the processor may be any conventional processor, controller, microcontroller or state machine. The processor may also be implemented in a combination of computing devices, such as a combination of a DSP and a microprocessor, multiple microprocessors, one or more microprocessors integrated with a DSP core, or any other such configurations.

The disclosed methods or algorithm steps herein may be embodied in hardware directly, in software modules executed by the processor, or in a combination of both. The software modules may reside in an RAM memory, a flash memory, an ROM memory, an EPROM memory, an EEPROM memory, a register, a hard disk, a removable disk, a CD-ROM, or any other form of storage medium known in the field. The exemplary storage medium is coupled to the processor, such that the processor can read information from the storage medium or write information to the storage medium. Alternatively, the storage medium may be integrated with the processor. The processor and the storage medium may reside in an ASIC. The ASIC may reside in a user terminal. Alternatively, the processor and the storage medium may reside as discrete components in the user terminal.

In one or more exemplary designs, the functions as described may be implemented in hardware, software, firmware, or any combination thereof. If the functions are implemented in software, then the functions may be stored on a computer-readable medium or transmitted via a computer-readable medium as one or more instructions or codes. The computer-readable medium includes a computer storage medium and a communication medium. The communication medium includes any medium that can help to transmit a computer program from one location to another location. The storage medium may be any usable medium that may be accessed by a general-purpose or special-purpose computer. As a non-limiting example, the computer-readable medium may include an RAM, an ROM, an EEPROM, a CD-ROM or other optical disk storage device, a magnetic disk storage device or other magnetic storage device, or any other medium that may be used for carrying or storing desired program code in the form of instructions or data structures and can be accessed by a general-purpose or special-purpose computer or a general-purpose or special-purpose processor. In addition, any connection may be properly referred to as a computer-readable medium. For example, if a coaxial cable, an optical fiber cable, a twisted pair, a digital subscriber line (DSL) or a wireless technology such as infrared, radio and microwave is used for sending software from a website, a server, or other remote sources, then the above coaxial cable, optical fiber cable, twisted pair, DSL or wireless technology such as infrared, radio and microwave are all included in the definition of medium. As used herein, the magnetic disk and the optical disk include a compact disc (CD), a laser disc, an optical disc, a digital versatile disc (DVD), a floppy disk and a blu-ray disc, wherein the magnetic disk magnetically reproduces data usually, while the optical disk reproduces data using laser optics. Combinations of the above contents should also be included within the scope of the computer-readable medium.

While the present disclosure above shows illustrative embodiments of the present disclosure, but it should be noted that, without departing from the scope of the present disclosure as defined by the claims, various changes and modifications may be figured out. The functions, steps and/or actions of the method claims according to the various embodiments described herein are not required to be executed in any particular order. Furthermore, although an element of the present disclosure can be described or claimed in singular form, a plurality can be envisaged, unless explicitly restricted to be singular.

It is to be understood that as used herein, the singular forms “a”, “an”, and “the” include the plural reference unless the context clearly dictates otherwise. It should also be understood that as used herein, the term “and/or” includes any or all possible combinations of one or more of the associated listed items.

The numbers of the foregoing embodiments of the present disclosure are for description only, and do not represent the ranking of the embodiments.

It may be understood by those having ordinary skills in the art that the all or part steps of implementing the foregoing embodiments may be finished through hardware or may be finished through relevant hardware instructed by a program. The program may be stored in a computer readable storage medium, and the storage medium mentioned above may be a read-only memory (ROM), a magnetic tape, or a optical disk, and the like.

The foregoing is merely preferred embodiments of the present disclosure, but is not intended to limit the present disclosure; and any modification, equivalent replacement, improvement and the like made within the spirits and principles of the present disclosure shall all fall within the protection scope of the present disclosure.

What is claimed is:

1. A method for displaying user-defined control based on Android platform, comprising:
detecting an instruction of opening a user-defined control in an application interface;
invoking a user-defined control interface of the application, and reading the user-defined control packed in an Android system and corresponding to the application, wherein the user-defined control interface defines select controls corresponding to the style of the application interface comprised in the user-defined control, a logical relation between the select controls, and a display category of the user-defined control; and
displaying the select control according to the display category and the logical relation, when the user-defined control is displayed in the application interface.

2. The method according to claim 1, wherein, the user-defined control is a date select control, the date select control comprises three wheel select controls, a date logical relation is formed among the three wheel select controls, and the display category is a dialog box; and
wherein the displaying the select control according to the display category the logical relation when the user-defined control is displayed in the application interface comprises:
displaying the three wheel select controls according to the date logical relation in a manner of dialog box when the date select control is displayed in the application interface.

3. The method according to claim 1, wherein, the user-defined control is a time select control, the time select control comprises three wheel select controls, a date logical relation is formed among the three wheel select controls, and the display category is a dialog box; and
wherein the displaying the select control according to the display category and the logical relation when the user-defined control is displayed in the application interface comprises:
displaying the three wheel select controls according to the time logical relation in a manner of dialog box when the time select control is displayed in the application interface.

4. The method according to claim 2, wherein, the attributes of at least two of the wheel select controls are preset as display.

5. The method according to claim 1, wherein, the invoking the user-defined control interface of the application comprises:
reading a layout file of the application;
invoking the user-defined control interface prewritten in the layout file;
or,
invoking the user-defined control interface prewritten from the logical code of the application.

6. A device for displaying user-defined control based on Android platform, comprising:
an instruction detecting module configured to detect an instruction of opening a user-defined control in an application interface;
a control reading module configured to invoke a user-defined control interface of the application, and read the user-defined control packed in an Android system and corresponding to the application, wherein the user-defined control interface defines select controls corresponding to the style of the application interface comprised in the user-defined control, a logical relation between the select controls, and a display category of the user-defined control; and
a control displaying module configured to display the select control according to the display category and the logical relation when the user-defined control is displayed in the application interface.

7. The device according to claim 6, wherein, the user-defined control is a date select control, the date select control comprises three wheel select controls, a date logical relation is formed among the three wheel select controls, and the display category is a dialog box; and
wherein the control display module comprises:
a first displaying submodule configured to display the three wheel select controls according to the date logical relation in a manner of dialog box when the date select control is displayed in the application interface.

8. The device according to claim 6, wherein, the user-defined control is a time select control, the time select control comprises three wheel select controls, a date logical relation is formed among the three wheel select controls, and the display category is a dialog box; and
wherein the control display module comprises:
a second displaying submodule configured to display the three wheel select controls according to the time logical relation in a manner of dialog box when the time select control is displayed in the application interface.

9. The device according to claim 6, wherein, the control reading module comprises:
a layout file reading submodule configured to read a layout file of the application;
a first invoking submodule configured to invoke the user-defined control interface prewritten in the layout file;
or,
a second invoking submodule configured to invoke the user-defined control interface prewritten from the logical code of the application.

10. A device for displaying user-defined control based on Android platform, comprising:
a processor; and
a memory for storing instructions executable by the processor;
wherein the processor is configured to:
detect an instruction of opening a user-defined control in an application interface;
invoke a user-defined control interface of the application, and read the user-defined control packed in an Android system and corresponding to the application, wherein the user-defined control interface defines select controls corresponding to the style of the application interface comprised in the user-defined control, a logical relation between the select controls, and the display category of the user-defined control; and
display the select control according to the display category and the logical relation when the user-defined control is displayed in the application interface.

11. The device according to claim 10, wherein, the user-defined control is a date select control, the date select control comprises three wheel select controls, a date logical relation is formed among the three wheel select controls, and the display category is a dialog box; and
wherein the display the select control according to the display category the logical relation when the user-defined control is displayed in the application interface comprises:
display the three wheel select controls according to the date logical relation in a manner of dialog box when the date select control is displayed in the application interface.

12. The device according to claim 10, wherein, the user-defined control is a time select control, the time select control comprises three wheel select controls, a date logical relation is formed among the three wheel select controls, and the display category is a dialog box; and
wherein the display the select control according to the display category and the logical relation when the user-defined control is displayed in the application interface comprises:
display the three wheel select controls according to the time logical relation in a manner of dialog box when the time select control is displayed in the application interface.

13. The device according to claim 11, wherein, the attributes of at least two of the wheel select controls are preset as display.

14. The device according to claim 10, wherein, the invoke the user-defined control interface of the application comprises:
read a layout file of the application;
invoke the user-defined control interface prewritten in the layout file;
or,
invoke the user-defined control interface prewritten from the logical code of the application.

15. The method according to claim 3, wherein, the attributes of at least two of the wheel select controls are preset as display.
